(19) United States
(12) Patent Application Publication
(10) Pub. No.: US 2021/0223211 A1
(43) Pub. Date: Jul. 22, 2021

(54) HAMMERING TEST TERMINAL, HAMMERING TEST SYSTEM, AND HAMMERING TEST DATA REGISTRATION METHOD

(71) Applicant: PANASONIC INTELLECTUAL PROPERTY MANAGEMENT CO., LTD., Osaka (JP)

(72) Inventors: Ryota FUJII, Fukuoka (JP); Akitoshi IZUMI, Fukuoka (JP); Kazunori HAYASHI, Fukuoka (JP); Ryoichi YUGE, Fukuoka (JP)

(73) Assignee: PANASONIC INTELLECTUAL PROPERTY MANAGEMENT CO., LTD., Osaka (JP)

(21) Appl. No.: 17/058,805

(22) PCT Filed: May 28, 2019
(86) PCT No.: PCT/JP2019/021008

§ 371 Date: Nov. 25, 2020

(30) Foreign Application Priority Data
May 28, 2018 (JP) 2018-101368
May 28, 2018 (JP) 2018-101369

(51) Int. Cl. G01N 29/11; G01P 15/18; H04R 1/22; H04R 1/40; H04R 1/02; H04W 4/80

(52) U.S. Cl. CPC G01N 29/11; G01P 15/18; H04R 1/222; H04R 2430/20; H04R 1/025; H04W 4/80; H04R 1/406

(57) ABSTRACT

A hammering test terminal is mounted by a user gripping a hammer and is communicably connected to an external device. The hammering test terminal includes a sound collection unit, a measuring unit that acquires position information indicating a current position of the hammering test terminal, a processor that generates hammering test data in which hammering signal data collected by the sound collection unit when the hammer is striking an object to be tested is associated with the position information, and a communication unit that transmits the generated hammering test data to the external device.

### TECHNICAL FIELD

The present disclosure relates to a hammering test terminal, a hammering test system, and a hammering test data registration method.

### BACKGROUND ART

Patent Literature 1 discloses determination of analysis about hammering on an object to be tested (for example, whether the hammering is performed correctly at a hammering point pointed by a laser beam or not, or whether force applied by the hammering is within a predetermined range or not).

In addition, in order to check for an internal fracture (such as cracking) of a structure (such as concrete), an operator strikes a surface of the structure by a hammer several times and hears sound reverberated from the struck structure (hereinafter referred to as “hammering sound”) with his/her ears to determine whether the internal fracture occurs or not.

On the other hand, Patent Literature 2 discloses a technique for striking a structure by a hammer and measuring hammering sound generated therefrom with a microphone so that a computer can diagnose a state of the structure. In the Patent Literature 2, the microphone is provided in an outer portion of the hammer, and an accelerometer is built in the hammer. The soundness of the structure is diagnosed by the computer based on a hammering signal measured by the microphone and a speed signal obtained from striking force measured by the accelerometer.

### CITATION LIST

### Patent Literature

Patent Literature 1: JP-A-2005-121571

Patent Literature 2: JP-A-2010-271116

### SUMMARY OF INVENTION

### Technical Problem

It is an object of the present disclosure to support proper test management for an object to be tested existing over a wide area in a hammering test performed by hammering on the object to be tested.

It is another object of the present disclosure to determine whether an operator struck an object to be tested properly by a hammer or not, and properly extract hammering signal data which is obtained when the object to be tested is struck by the hammer, so as to properly diagnose soundness (or existence/absence of an internal fracture and the like) of a structure.

### Solution to Problem

A hammering test terminal according to the present disclosure is a hammering test terminal that is mounted by a user gripping a hammer and communicably connected to an external device, the hammering test terminal including; a sound collection unit, a position measuring unit that acquires position information indicating a current position of the hammering test terminal; a processor that generates hammering test data in which hammering signal data collected by the sound collection unit when an object to be tested is being struck by the hammer is associated with the position information; and a communication unit that transmits the generated hammering test data to the external device.

A hammering test system according to the present disclosure is a hammering test system including: a hammer to which an acceleration sensor is attached; the hammering test terminal that is mounted by a user gripping the hammer; and a sound collection unit that is provided in the hammer or the hammering test terminal; wherein: the acceleration sensor acquires values of a speed and an inclination of the hammer measured when an object to be tested is being struck by the hammer; the hammering test terminal determines whether the user strikes the object to be tested by the hammer in accordance with a prescribed standard or not based on the measured values of the speed and the inclination of the hammer from the acceleration sensor; and hammering signal data collected by the sound collection unit when the object to be tested is being struck in accordance with the prescribed standard is recorded in an external device.

In addition, a hammering test data registration method is a method for registering hammering test data in a hammering test terminal that is mounted by a user gripping a hammer and communicably connected to an external device, the method including the steps of: acquiring position information indicating a current position of the hammering test terminal; collecting sound by a sound collection unit; generating hammering test data in which hammering signal data collected by the sound collection unit when an object to be tested is being struck by the hammer is associated with the position information; and transmitting the generated hammering test data to the external device.

### Advantageous Effects of Invention

According to the present disclosure, hammering signal data obtained when an operator struck an object to be tested by a hammer can be registered in association with information of a position where the operator struck the object to be tested, so that proper test management for the object to be tested existing over a wide area can be supported.

Further according to the present disclosure, it is possible to determine whether the operator struck the object to be tested by the hammer properly or not, and it is possible to properly extract the hammering signal data obtained when the operator struck the object to be tested by the hammer, so that soundness (or existence/absence of an internal fracture and the like) of a structure can be diagnosed properly.

### BRIEF DESCRIPTION OF DRAWINGS

FIG. 1 A block diagram showing a configuration of a hammering test system.

FIG. 2 A flow chart showing a hammering test procedure of a terminal device.

FIG. 3 A flow chart showing a movement stop detection procedure in Step S1.

FIG. 4 A flow chart showing a hammering detection procedure in Step S3.

FIG. 5 A flow chart showing a movement start detection procedure in Step S5.

FIG. 6 A timing chart showing a change of a hammering signal.

FIG. 7 A flow chart showing a hammering test procedure in Embodiment 2.

FIG. 8 A flow chart showing a test main processing procedure in Step S54.

FIG. 9 A flow chart showing a hammering detection procedure in Step S61.

FIG. 10 A flow chart showing a hammering determination procedure in Step S63.

FIG. 11 A flow chart showing a hammering position detection procedure in Step S65.

FIG. 12 A flow chart showing a data transmission determination procedure in Step S66.

FIG. 13 A view showing a hammering test screen displayed on a touch panel of a terminal device.

FIG. 14 A view showing a hammering test screen displayed on the touch panel of the terminal device during a hammering test.

FIG. 15 A view showing a test recording screen and a test recording graph displayed on a monitor of a cloud server.

### DESCRIPTION OF EMBODIMENTS

### Embodiment 1

In Embodiment 1, description will be made about an example of a hammering test terminal, a hammering test system and a hammering test data registration method, capable of determining whether an operator struck an object to be tested by a hammer properly or not, and properly extracting hammering signal data obtained when the operator struck the object to be tested.

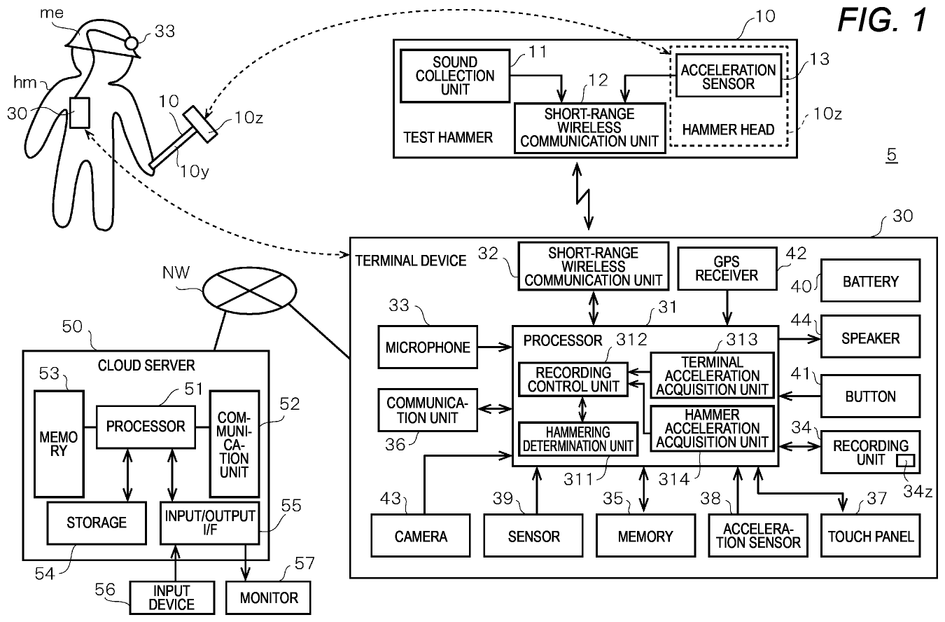

FIG. 1 is a block diagram showing a configuration of a hammering test system 5. The hammering test system 5 has a configuration including a test hammer 10, a terminal device 30, and a cloud server 50. The test hammer 10 and the terminal device 30 are connected so that data communication can be performed therebetween through short-range wireless communication. The terminal device 30 and the cloud server 50 are connected so that data communication can be performed therebetween through a network NW. The terminal device 30 is a portable terminal or a tablet terminal.

The test hammer 10 includes a hammer head 10z and a grip portion 10y. In a hammering test, an operator hm grips the grip portion 10y and strikes an object to be tested with the hammer head 10z to apply a striking force to a hammered surface of the object to be tested.

The test hammer 10 includes a sound collection unit 11, a short-range wireless communication unit 12, and an acceleration sensor 13. The sound collection unit 11 is a single microphone which is attached to a surface of the grip portion 10y and has directivity toward the hammer head 10z. Incidentally, the sound collection unit 11 may be an omnidirectional microphone, or may be a microphone array which forms a directivity direction in a predetermined direction so that the microphone array can collect sound in the directivity direction. The sound collection unit 11 collects sound including hammering sound which is generated when the object to be tested is struck with the hammer head 10z.

The acceleration sensor 13 is built in the hammer head 10z so as to detect an acceleration and an acceleration direction (a striking force and a striking direction of the hammer head 10z) with which the object to be tested is struck with the hammer head 10z, and to acquire the acceleration and the acceleration direction as detection data. As the detection data, the acceleration sensor 13 may acquire a speed and an inclination obtained from a value of the acceleration. A sensor which can be mounted on an electronic board, for example, by use of technology of MEMS (Micro Electro Mechanical Systems) can be used as the acceleration sensor. The acceleration sensor 13 can detect the acceleration in three-axis (X, Y and Z axes) directions.

Just before the hammer head 10z strikes the object to be tested, the acceleration of the hammer head 10z detected by the acceleration sensor 13 shows a large value. The acceleration direction is a direction perpendicular to and approaching the hammered surface of the object to be tested.

Just after the hammer head 10z struck the object to be tested, the acceleration of the hammer head 10z detected by the acceleration sensor 13 shows a minimum value (negative maximum value). The acceleration direction (deceleration direction) is a direction perpendicular to and leaving the hammered surface of the object to be tested.

The short-range wireless communication unit 12 performs short-range wireless communication with the terminal device 30 to transmit, to the terminal device 30, sound data of the sound collected by the sound collection unit 11 and detection data (data of the acceleration and the acceleration direction) detected by the acceleration sensor 13. The short-range wireless communication is performed, for example, by Bluetooth (registered trademark).

The terminal device 30 is carried by the operator hm so that the operator hm can operate the terminal device 30 desirably. The terminal device 30 includes a processor 31, a short-range wireless communication unit 32, a microphone 33, a recording unit 34, a memory 35, a communication unit 36, a touch panel 37, an acceleration sensor 38, a sensor 39, a battery 40, a button 41, a GPS receiver 42, a camera 43, and a speaker 44.

The processor 31 controls operation of each portion of the terminal device 30. The processor 31 has functions as a hammering determination unit 311, a recording control unit 312, a terminal device acceleration acquisition unit 313, and a hammer acceleration acquisition unit 314 respectively. The terminal device acceleration acquisition unit 313 acquires data detected by the acceleration sensor 38 which is built in the terminal device 30 so as to detect movement of the operator hm. The hammer acceleration acquisition unit 314 acquires detection data of the acceleration and the acceleration direction (inclination) of the test hammer 10 detected by the acceleration sensor 13 which is built in the test hammer 10.

The recording control unit 312 controls operation of recording (sound-recording), in the recording unit 34, sound data of the sound collected by the sound collection unit 11. The recording control unit 312 determines whether to record the sound data or not based on the data acquired by the terminal device acceleration acquisition unit 313 and the data acquired by the hammer acceleration acquisition unit 314.

Based on the detection data (the data of the acceleration and the acceleration direction) detected by the acceleration sensor 13, the hammering sound determination unit 311 evaluates frequency characteristics of a hammering signal and determines whether it is a hammering sound or not. In addition, the hammering sound determination unit 311 analyzes the result of the hammering sound determination (performs hammering sound analysis to determine the result as OK/NG) based on learning data accumulated in the recording unit 34. In this hammering sound analysis, the hammering sound determination unit 311 may use a learnt model which has been trained by machine learning with learning data.

In addition, the processor 31 accumulates results of the hammering sound analysis and hammering signal data in the recording unit 34 in order to use them as the learning data. The learning data may include parameters (physical quantities) such as temperature and humidity detected by the sensor 39 during hammering, and data determined as influencing hammering sound, in addition to the results of the hammering sound analysis and the hammering signal data. The processor 31 transmits the learning data to the cloud server 50 through the communication unit 36 and the network NW.

The short-range wireless communication unit 32 performs short-range wireless communication with the test hammer 10 so as to receive measured data from the test hammer 10.

The microphone 33 is attached to a helmet me of the operator hm. Incidentally, the microphone 33 may be attached to a part such as a shoulder or a breast of working clothes. The microphone 33 is a reference microphone which is used for noise cancellation to cancel wind noise, ambient noise and the like included in the sound collected by the sound collection unit 11. Incidentally, the microphone 33 may be used as a microphone for collecting hammering sound of the test hammer 10. In that case, the microphone 33 may be a single microphone, or may be a microphone array which forms a directivity direction in a predetermined direction so that the microphone array can collect sound in the directivity direction. In Embodiment 2 which will be described later, a case where the microphone 33 is used as the microphone array will be shown.

The recording unit 34 is a storage including a large-capacity storage medium which can record a large amount of hammering signal data. The recording unit 34 includes a hammering database (DB) 34z in which a large number of features of hammering signal data have been registered. The memory 35 is a storage medium such as a ROM or a RAM. The communication unit 36 is connected to the network NW by wire or by wireless so that the communication unit 36 can make data communication with the cloud server 50.

The touch panel 37 has a display unit and an input unit and functions as a user interface (UI) for the operator hm. The acceleration sensor 38 is disposed inside the terminal device 30 carried by the operator hm, so as to detect movement of the operator hm. The sensor 39 detects physical quantities such as temperature and humidity. The battery 40 is a power source for the terminal device 30. The battery 40 is a secondary battery such as a lithium ion battery. The button 41 is a hard button which can be pushed down and operated by the operator hm. The button 41 includes a hammering test start button, a hammering button end button, etc. The GPS receiver 42 receives a GPS signal from a GPS satellite and acquires position data (a latitude, a longitude, and an altitude).

The camera 43 takes an image of the hammered surface of the object to be tested, which surface will be struck by the test hammer 10, and the camera 43 also takes an image of an ambient environment around a test position or the like. The images taken by the camera 43 may be still images or moving images. The speaker 44 outputs a voice. For example, the speaker 44 informs the operator hm of information about the hammering test.

The cloud server 50 includes a processor 51, a communication unit 52, a memory 53, a storage 54, and an input/output interface (I/F) 55. The communication unit 52 is connected to the network NW by wire or by wireless so that the communication unit 52 can make data communication with the terminal device 30. The memory 53 is a storage medium such as a ROM or a RAM. The storage 54 includes a large-capacity storage medium which can record a large amount of data. An input device 56 and a monitor 57 are connected to the input/output I/F 55. The input device 56 accepts various operations about the hammering test. The monitor 57 displays various kinds of information about the hammering test.

When the processor 51 receives the data of the acceleration (speed) and the acceleration direction (inclination) of the acceleration sensor 13, the hammering signal data, the results of the hammering sound analysis, etc. from the terminal device 30 through the communication unit 52, the processor 51 accumulates those received data in the storage 54. The processor 51 performs machine learning using the aforementioned data as learning data, and creates a leant model in the storage 54. The processor 51 may offer the learnt model to the terminal device 30, or may use the learnt model to determine whether the sound is a hammering sound or not, or perform hammering sound analysis, in accordance with a request from the terminal device 30.

Operation of the hammering test system 5 configured thus will be illustrated.

For example, assume a case where a concrete structure such as a pier supporting a highway or a bridge is diagnosed as the object to be tested. When the concrete structure has an internal defect (crack), the internal defect can be diagnosed by performing a hammering test.

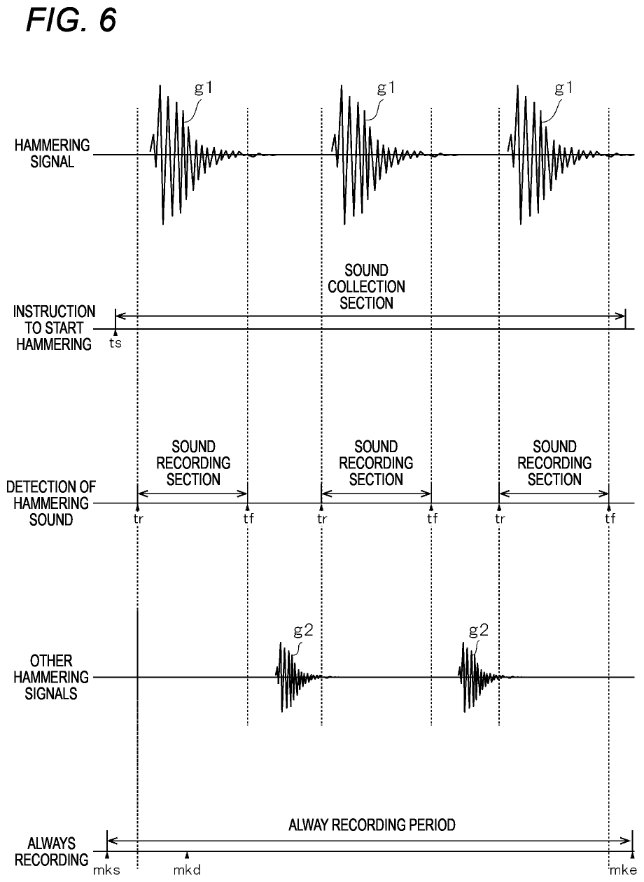

The operator hm gives an instruction of start to the terminal device 30 before starting a hammering test, that is, before striking the object to be tested by the test hammer 10. The instruction may be issued in such a manner that the operator hm utters a voice “start hammering test”, and the microphone 33 collects the voice. Alternatively, the operator hm may push down the test start button included in the button 41 of the terminal device 30 in order to start the hammering test. When the instruction to start the test is given, the terminal device 30 informs the test hammer 10 of the instruction through the short-range wireless communication unit 32. When the short-range wireless communication unit 12 receives the instruction, the sound collection unit 11 performs an operation of collecting sound for a predetermined period (e.g. 1 minute). A timing is (see FIG. 6) when the instruction is given serves as a start point of a sound collection section to be performed for the predetermined period.

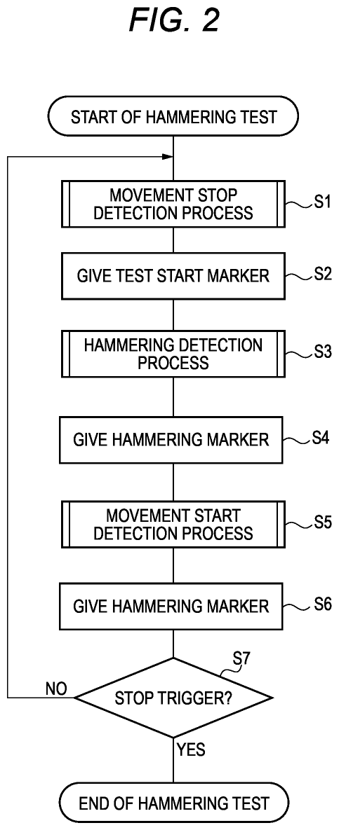

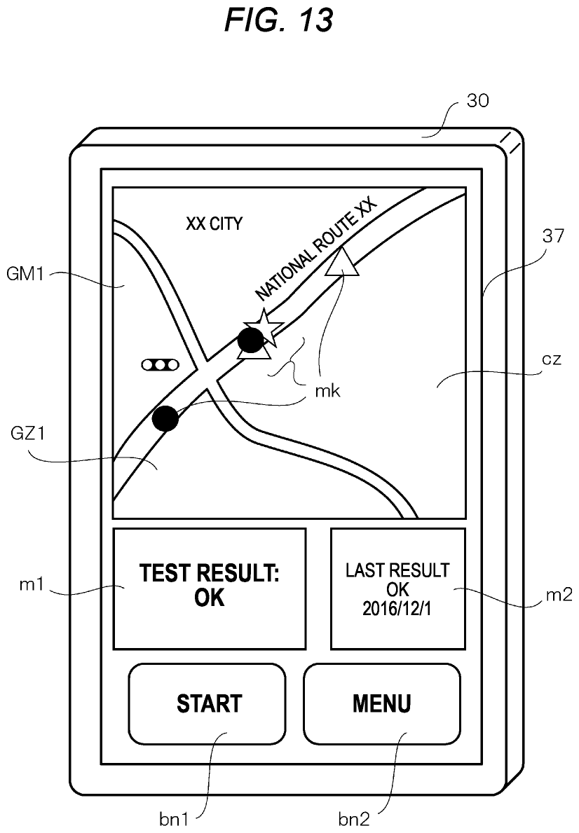

FIG. 2 is a flow chart showing a hammering test procedure of the terminal device 30. At the start of the hammering test, the processor 31 displays results (yellow marks mk in FIG. 13) of last hammering tests on the touch panel 37. Incidentally, the processor 31 may make voice guidance on the speaker 44 about the results of the last hammering tests.

In a case where the hammering test is performed in an always recording mode in which sound data of sound collected by the sound collection unit 11 is always recorded in the recording unit 34, the terminal device 30 gives markers to measured data recorded in time series, so that time of each event can be recognized. In a mode other than the always recording mode, the terminal device 30 does not have to give the markers, but processes of Step S2, S4 and S6 which will be described later may be removed.

The processor 31 of the terminal device 30 performs a movement stop detection process to detect movement stop of the operator hm based on the detection data outputted from the acceleration sensor 38 (S1). When the movement stop of the operator hm is detected, the processor 31 gives a test start marker mks (see FIG. 6) indicating a test start time (S2). The test start marker mks means start of recording.

The processor 31 performs a hammering detection process to detect that the object to be tested is struck by the test hammer 10 (S3). The hammering detection process will be described in detail later. When hammering sound is detected, the processor 31 gives a hammering marker mkd (S4). The processor 31 performs a movement start detection process to detect movement start of the operator hm based on the detection data outputted from the acceleration sensor 38 (S5).

When the movement start of the operator hm is detected, the processor 31 gives a test end marker mke indicating a test end time (S6). On this occasion, the processor 31 may inform the operator of a next position to be struck or a leakage of a voice on the speaker 44.

The processor 31 determines whether there is a trigger to suspend the hammering test or not (S7). The trigger to suspend the hammering test is, for example, that the operator hm pushes down the hammering stop button included in the button 41. Alternatively, the trigger may be that the operator hm issues a void for ending the test toward the microphone 33. When there is no trigger to suspend the hammering test, the processor 31 returns to the process of Step S1. On the other hand, when there is a trigger to suspend the hammering test, the processor 31 terminates the present process as it is.

In the case of the always recording mode, the period between the time when the test start marker mks is given in Step S2 and the time when the test end marker mke is given in Step S6 corresponds to a recording period (see FIG. 6).

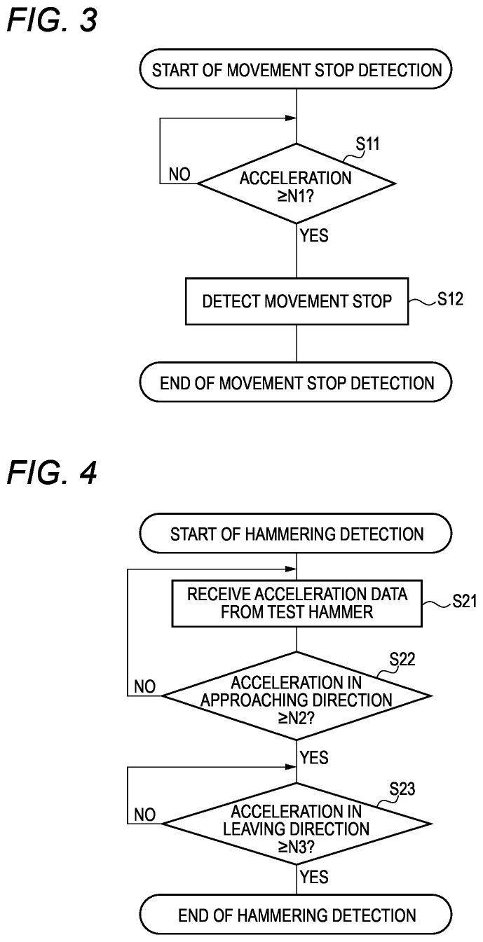

FIG. 3 is a flow chart showing a movement stop detection procedure in Step S1. The processor 31 determines whether the absolute value of the acceleration detected within a predetermined time by the acceleration sensor 38 reaches at least a threshold N1 or not (S11). The predetermined time is, for example, a time required for performing the hammering test at one place. The absolute value of the acceleration of the operator shows a small fluctuated value during movement or stop of the operator. On the other hand, the absolute value tends to show a large value at the moment the operator who is moving begins to stop or at the moment the operator who is stopping begins to move. Accordingly, in FIG. 3, on detecting that the absolute value of the acceleration is a value smaller than the threshold N1, the processor 31 determines that the operator hm is moving, and repeats the process of Step S11.

On the other hand, on detecting that the absolute value of the acceleration is on or beyond the threshold N1, the processor 31 determines that the operator hm has just stopped, and detects the movement stop (S12). The movement stop may be displayed on the touch panel 37, or may be transmitted to the cloud server 50. After that, the processor 31 terminates the present process, and returns to its original process. Incidentally, the determination process in Step S11 may be performed as determination including the direction of the acceleration without using the absolute value of the acceleration.

FIG. 4 is a flow chart showing a hammering detection procedure in Step S3. The processor 31 issues a request to transmit data of the acceleration detected by the acceleration sensor 13, to the test hammer 10 through the short-range wireless communication unit 32. The short-range wireless communication unit 12 of the test hammer 10 responds to the request and transmits the data of the acceleration detected by the acceleration sensor 13, to the terminal device 30 at short time intervals.

The processor 31 receives the data of the acceleration from the test hammer 10 (S21). The processor 31 acquires an acceleration (for example, a peak acceleration) and an acceleration direction (inclination of the hammer head 10z) included in the received data of the acceleration. The processor 31 determines whether the acceleration of the hammer head 10z in a perpendicular and positive direction to the hammered surface of the object to be tested is at least a threshold N2 or not (S22). The perpendicular and positive direction is a direction (approaching direction) in which the hammer head approaches the hammered surface perpendicularly thereto. Here it is determined whether the hammer head 10z struck the hammered surface in accordance with a prescribed standard or not, that is, whether the hammer head 10z struck the hammered surface properly from its front direction or not. The threshold N2 is set at a value for determining whether the speed with which the hammer head 10z struck the hammered surface is sufficient or not (a value suitable for a start timing to acquire a hammering signal).

When the acceleration of the hammer head 10z in the perpendicular and positive direction is below the threshold N2, the processor 31 determines that the hammered surface is not struck by the test hammer 10, and returns to the process of Step S21 to promote hammering by the test hammer 10 again.

In addition, in Step S22, when the acceleration of the hammer head 10z in the perpendicular and positive position to the hammered surface of the object to be tested is on or beyond the threshold N2, the processor 31 then determines whether the acceleration of the hammer head 10z in a perpendicular and negative direction to the hammered surface of the object to be tested is at least a threshold N3 or not (S23). The speed of the hammer head 10z takes a value of 0 at the moment the hammer head 10z strikes the hammered surface of the object to be tested. Therefore, the acceleration of the hammer head 10z is inverted to take a large and negative value. The perpendicular and negative direction is a direction (leaving direction) in which the hammer head leaves the hammered surface perpendicularly thereto. The threshold N3 is set at a value suitable for a timing of ending acquiring a hammering signal. For example, the timing of ending acquiring a hammering signal may be set at a timing in which a predetermined time (time required for the hammering signal to be attenuated) is added to the timing when the acceleration of the hammer head 10z in the perpendicular and negative direction reaches the threshold N3 or more. Alternatively, the timing of ending acquiring a hammering signal may be set at a timing in which a predetermined time (time required for the hammering signal to be attenuated) is added to the time when the hammering marker mkd is given.

When the acceleration of the hammer head 10z in the perpendicular and negative direction is below the threshold N3, the processor 31 determines that the test hammer 10 is striking the hammered surface and does not finish striking yet, and repeats the process of Step S23. As soon as the acceleration of the hammer head 10z in the perpendicular and negative direction reaches the threshold N3 or more, the processor 31 terminates striking by the test hammer 10, and acquires a hammering signal. After that, the processor 31 terminates the present process and returns to its original process.

When the hammered surface of the object to be tested is struck by the test hammer 10, the sound collection unit 11 collects hammering sound generated from the hammered surface of the object to be tested. After a short time has passed since the striking, the hammering signal collected by the sound collection unit 11 increases suddenly, and then decreases gradually as shown by a hammering signal waveform g1 in FIG. 6.

In this manner, the processor 31 extracts hammering signal data among sound signal data collected by the sound collection unit 11, based on the detection data (measured values) about the acceleration (speed) and the acceleration direction (inclination) of the test hammer 10 detected by the acceleration sensor 13. When the processor 31 can extract the hammering signal data, the processor 31 adds 1 to the number of times of striking to count it. The extracted hammering signal data is recorded in the recording unit 34 by the processor 31, and also transmitted to the cloud server 50.

Incidentally, here, the way of hammering is determined as OK/NG based on the value of the acceleration detected by the acceleration sensor 13. However, the operator hm may determine the way of hammering as OK/NG and input the result of the determination into the terminal device 30. For example, using a switch included in the button 41 of the terminal device 30, the operator hm may perform operation of pushing the switch twice for OK and pushing the switch once for NG. Incidentally, the switch may be provided in the grip portion 10y of the test hammer 10. Alternatively, voice data of “OK” or “NG” pronounced by the operator hm may be collected by the sound collection unit 11. Further, the way of hammering may be determined as OK/NG in accordance with whether the time for which the operator hm stays for repairing at one and the same place is long or short. Further, the operator hm may input the number of times of striking by the test hammer 10 so that the way of hammering can be determined as OK/NG based on the inputted number of times. The result of the determination about the way of hammering by the operator hm may be transmitted to the cloud server 50 as learning data together with the hammering signal data or the detection data of the acceleration sensor.

In addition, when the way of hammering is NG, the processor 31 may display a message such as “Strike again” on the touch panel 37 so as to promote the operator hm to strike by the test hammer again.

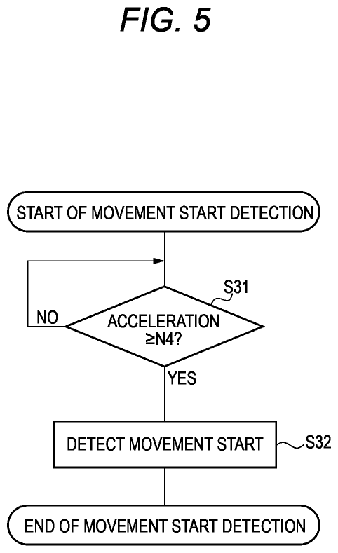

FIG. 5 is a flow chart showing a movement start detection procedure in Step S5. The processor 31 determines whether the absolute value of the acceleration detected within a predetermined time by the acceleration sensor 38 reaches at least a threshold N4 or not (S31). The predetermined time is, for example, set at a time required for performing the hammering test at one place. The absolute value of the acceleration of the operator shows a small fluctuated value during movement or stop of the operator. On the other hand, the absolute value tends to show a large value at the moment the operator who is moving begins to stop or at the moment the operator who is stopping begins to move. Accordingly, in FIG. 5, on detecting that the absolute value of the acceleration is a value smaller than the threshold N4, the processor 31 determines that the operator hm is stopping, and repeats the process of Step S31.

On the other hand, in Step S31, on detecting that the absolute value of the acceleration is on or beyond the threshold N4, the processor 31 determines that the operator hm has begun to walk, and detects the movement start (S32). The movement start may be displayed on the touch panel 37, or may be transmitted to the cloud server 50. The determination process in Step S31 may be performed as determination including the direction of the acceleration without using the absolute value of the acceleration. After that, the processor 31 terminates the present process, and returns to its original process.

Incidentally, here, the movement stop and the movement start are determined using the acceleration detected by the acceleration sensor. However, when a position measuring signal from a GPS satellite can be received, the movement stop and the movement start may be determined based on position data (a latitude, a longitude, and an altitude) obtained from the GPS receiver.

FIG. 6 is a timing chart showing a change in a hammering signal. In FIG. 6, assume a case where the operator hm strikes the object to be tested by the test hammer 10 three times, and the sound collection unit 11 collects sound generated therefrom.

As soon as the operator hm pushes down a start button bn1 displayed on the touch panel 37, a hammering test starts at a timing ts. The sound collection unit 11 begins to collect sound at the timing ts, and keeps on collecting sound for a predetermined period (for example, for one minute).

When striking with the hammer head 10z of the test hammer 10 is applied to the hammered surface of the object to be tested, the acceleration of the acceleration sensor 13 reaches the threshold N2 or more. At this timing tr, the processor 31 starts an operation of recording, in the recording unit 34, hammering signal data of hammering sound collected by the sound collection unit 11. When striking is applied to the object to be tested, a hammering signal increases suddenly after a short time has passed since the striking, and then decreases gradually, as shown by the waveform g1 of the hammering signal.

At a timing tf in which a predetermined time has passed since the timing tr, the processor 31 ends the operation of recording, in the recording unit 34, the hammering signal data of the hammering sound collected by the sound collection unit 11. The predetermined period (between the timing ts and the timing tf) is a recording period required for the hammering signal to reach a sufficiently attenuated state. The predetermined period is, for example, 3 seconds. After that, in the same manner, when the acceleration of the acceleration sensor 13 reaches the threshold N2 or more, the processor 31 repeats the operation of starting the recording operation at the timing tr and ending the recording operation at the timing tf. As a result, only the hammering signal data for the predetermined period (between the timing ts and the timing tf), that is, only the sound data at the moment of each hammering is recorded. In FIG. 6, the hammering signal data corresponding to the hammering performed three times are recorded in the recording unit 34. Accordingly, even when a waveform g2 of hammering sound from a hammering test performed by another operator is generated, hammering signal data of the sound is not recorded in the recording unit 34.

In this manner, when the value of the acceleration sensor 13 is used, only a range of sound corresponding to the moment of each hammering can be extracted as hammering signal data. Accordingly, it is possible to reduce misrecognition of sound generated from hammering performed by another operator near the operator hm. In addition, in a case where the operator hm forgets to perform the test start operation (to push the start button, to send a start signal, etc.), the processor 31 can send some information to the operator hm, or can perform the test start operation to begin to record sound generated from hammering without sending the information.

### Embodiment 2

In order to check whether there is an internal fracture (such as cracking) of a structure (such as concrete) or not, an operator strikes a surface of the structure by a hammer several times and hears sound reverberated from the struck structure (hereinafter referred to as “hammering sound”) with his/her ears to determine whether the internal fracture occurs or not.

On the other hand, JP-A-2010-271116 discloses a technique in which a structure is struck by a hammer, and hammering sound generated therefrom is measured by a microphone so that a computer can diagnose the condition of the structure. According to this literature, the hammer has the microphone in an outer portion thereof, and has an accelerometer built therein. The computer diagnoses the soundness of the structure based on a hammering signal measured by the microphone and a speed signal obtained by a striking force measured by the accelerometer.

In Embodiment 2, description will be made about an example of a hammering test terminal and a hammering test data registration method, in which hammering signal data obtained when the operator struck the object to be tested by the hammer is registered in association with information about the position where the operator struck the object to be tested, so as to support proper test management for the object to be tested existing over a wire area.

The hammering test system in Embodiment 2 has a similar configuration to that in Embodiment 1. Therefore, constituent elements the same as those in Embodiment 1 are referenced correspondingly, and their description will be omitted. In Embodiment 2, the sound collection unit 11 of the test hammer 10 is a microphone array. Incidentally, the sound collection unit 11 of the test hammer 10 may be provided as a single microphone while the microphone 33 of the terminal device 30 (the microphone 33 attached to the helmet me of the operator hm) is provided as a microphone array.

The microphone array is a microphone which forms directivity in a predetermined direction so that sound in the directivity direction can be collected. The microphone array includes a plurality (for example, eight) of microphones, a plurality of delays units, and an adder. In the microphone array, the delay units give delay times corresponding to differences in arrival time among the microphones to sound data of sound collected by the microphones respectively so as to align all the phases of acoustic waves thereof, and the sound data subjected to the delay processing are then added to one another by the adder. The microphone array changes the delay times set in the delay units to detect sound data in which the directivity has been formed in the predetermined direction, and extract and output the sound data in the directivity direction. Incidentally, the delay units and the adder may be built not in the microphone array but in the processor 31. In this case, the processor 31 extracts the sound data in the directivity direction using the sound data collected by the microphones.

The processor 31 estimates a sound source direction based on the sound data in the directivity direction collected by the microphone array. When the sound source direction corresponds to the hammered surface direction (front direction) of the object to be tested struck with the hammer head 10z, the processor 31 determines that the sound data is hammering sound. In addition, in order to acquire second or later hammering sound, the processor 31 may give an instruction to the microphone array so that the directivity can be formed in the sound source direction of the first hammering sound.

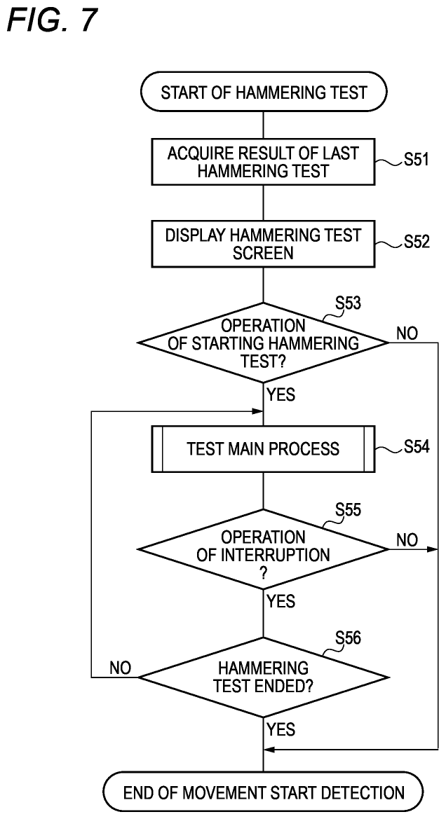

FIG. 7 is a flow chart showing a hammering test procedure in Embodiment 2. The processor 31 of the terminal device 30 acquires result data of the last hammering test (S51). In a case where the result data of the last hammering test has been accumulated in the cloud server 50, the processor 31 receives the result data of the last hammering test from the cloud server 50 through the communication unit 36 and the network NW. The communication unit 36 makes communication with the communication unit 52 of the cloud server 50 through the network NW, and receives the result data of the last hammering test accumulated in the storage 54. The communication unit 36 stores the received result data of the last hammering test into the recording unit 34. Incidentally, in a case where the result data of the last hammering test has been stored in the recording unit 34, the processor 31 reads out the result data of the last hammering test stored in the recording unit 34 without receiving it from the cloud server 50.

The processor 31 displays a hammering test screen GM1 (see FIG. 13) on the touch panel 37 (S52). The hammering test screen GM1 is a default screen including a determination m2 of the last test result. The processor 31 determines whether the user has pushed down the start button bn1 on the touch panel 37 to perform an operation of starting a hammering test or not (S53). When the operation of starting the hammering test has not been performed, the processor 31 terminates the present process.

When the operation of starting the hammering test has been performed in Step S53, the processor 31 performs a test main process (S54). In the test main process, an operation serving as a main part of the hammering test is performed.

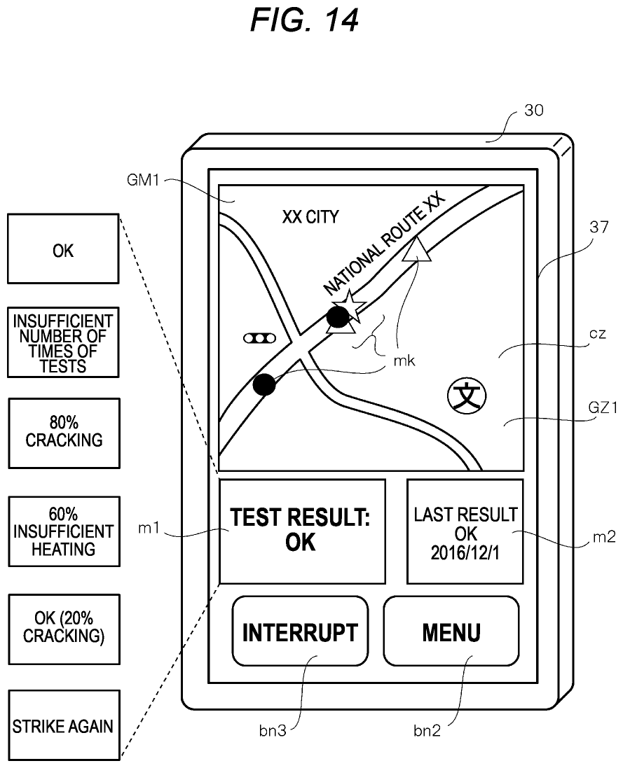

The processor 31 determines whether the user has pushed down an interruption button bn3 (see FIG. 14) on the touch panel 37 to perform an operation of interrupting the hammering test or not (S55). When the operation of interrupting the hammering test has been performed, the processor 31 terminates the present process.

When the operation of interrupting the hammering test has not been performed in Step S55, the processor 31 determines whether the hammering test has been performed a specified number of times and the hammering test should be ended or not (S56). The number of times of the hammering test is set in advance by the operator hm, and stored in the memory 35. In addition, whenever the hammering test is performed, the number of times of the hammering test is counted up by the processor 31. The specified number is a number required for obtaining a correct result of the hammering test. The specified number is, for example, three, five, or the like. Incidentally, independently of the number of times of the hammering test, the hammering test may be ended by the user pushing down an end button (not shown) displayed on the touch panel 37. The end button is, for example, one of buttons expanded by pushing down a menu button bn2. When the hammering test is performed the specified number of times and terminated, the hammering test screen GM1 (see FIG. 14) is updated. When the hammering test is not terminated, the processor 31 returns to Step S54, where the processor 31 continues the test main process. In addition, when the hammering test is terminated in Step S56, the processor 31 terminates the present process.

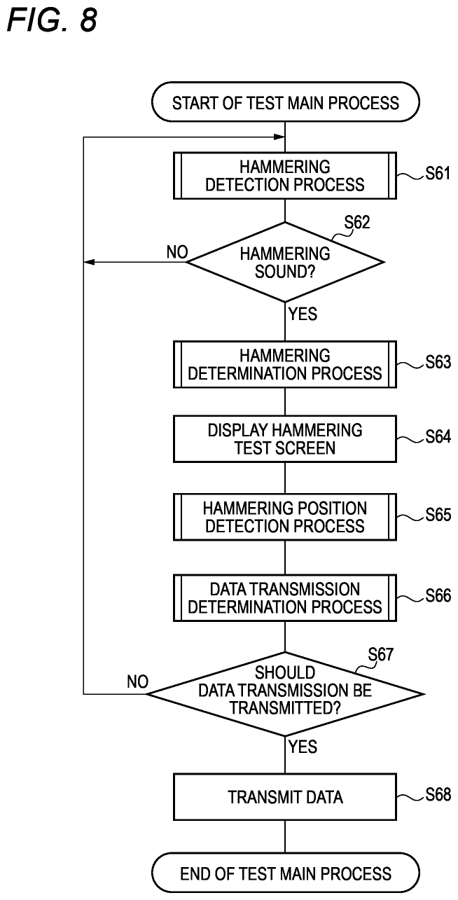

FIG. 8 is a flow chart showing a test main process procedure in Step S54. In the same manner as in Embodiment 1, the processor 31 performs a hammering detection process for detecting hammering sound (S61). As a result of the hammering detection, the processor 31 determines whether hammering sound has been detected or not (S62). When hammering sound has not been detected, the processor 31 returns to the process of Step S61.

On the other hand, when hammering sound has been detected, the processor 31 performs a hammering determination process (S63). The processor 31 displays the hammering test screen GM1 (see FIG. 14) including the result of the hammering sound determination on the touch panel 37 (S64).

The processor 31 performs a hammering position detection process of detecting a position (a latitude, a longitude, and an altitude) where the hammering test has been performed (S65). The processor 31 performs a data transmission determination process of determining whether to transmit the hammering signal data, the hammering sound determination result data and the hammering position data or not (S66). Here, data including the hammering signal data, the hammering sound determination result data and the hammering position data is referred to as hammering test data.

As a result of the data transmission determination, the processor 31 determines whether to transmit the hammering test data or not (S67). When the hammering test data is not transmitted, the processor 31 returns to the process of Step S61. On the other hand, when the hammering test data is transmitted, the processor 31 transmits the hammering test data to the cloud server 50 (S68). The communication unit 36 makes communication with the communication unit 52 of the cloud server 50 through the network NW, and transmits the hammering test data thereto. The processor 51 of the cloud server 50 stores, into the storage 54, the hammering test data received through the communication unit 52.

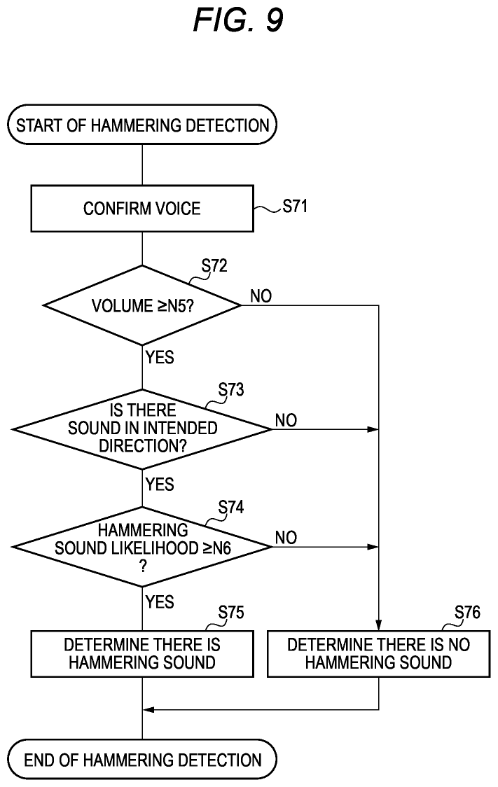

FIG. 9 is a flow chart showing a hammering detection procedure in Step S61. The processor 31 confirms sound data transmitted from the test hammer 10 through the short-range wireless communication unit 32 (S71). In the test hammer 10, sound is collected by the sound collection unit 11. The short-range wireless communication unit 12 of the test hammer 10 makes communication with the short-range wireless communication unit 32 of the terminal device 30, and transmits, to the short-range wireless communication unit 32, sound data of the sound collected by the sound collection unit 11. The processor 31 of the terminal device 30 receives the sound data through the short-range wireless communication unit 32. In addition, the short-range wireless communication unit 12 of the test hammer 10 transmits detection data of the acceleration detected by the acceleration sensor 13, together with the sound data of the sound collected by the sound collection unit 11. Accordingly, in Step S71, the processor 31 of the terminal device 30 also acquires the detection data of the acceleration detected by the acceleration sensor 13.

Based on the sound data, the processor 31 determines whether the volume (sound pressure level) of the sound collected by the sound collection unit 11 reaches at least a threshold N5 or not (S72). When the volume is below the threshold N5, the processor 31 determines that there is no hammering sound (S76). After that, the processor 31 terminates the present process, and returns to its original process.

When the volume is on or beyond the threshold N5 in Step S72, the processor 31 determines whether a direction (directivity direction) expressed by the sound data collected by the microphone 33 or the sound collection unit 11, that is, the sound collected by the microphone array is a sound in an intended direction or not (S73). When the sound collection unit 11 is a microphone array, the processor 31 checks whether the direction of the sound collected by the microphone array is a direction approaching the striking surface of the hammer head 10z from the position of the grip portion 10y to which the sound collection unit 11 has been attached. On the other hand, when the microphone 33 is a microphone array, the processor 31 checks whether the direction of the sound collected by the microphone array is a direction approaching the striking surface of the hammer head 10z from the microphone 33 attached to the helmet me. When the sound is not a sound in the intended direction, the processor 31 determines that there is no hammering sound, in Step S76. After that, the processor 31 terminates the present process, and returns to its original process.

When the sound is a sound in the intended direction in Step S73, the processor 31 determines whether hammering sound likelihood indicating hammering sound likelihood of the sound collected by the sound collection unit 11 reaches at least a threshold N6 or not (S74). The hammering sound likelihood can be obtained by the processor 31 using the hammering signal data accumulated in the recording unit 34 as learning data. For example, the processor 31 may import a learnt model of hammering signal data into the memory 35 from the cloud server 50 in advance. In this case, the processor 31 inputs the collected sound data into the learnt model to acquire hammering sound likelihood as an output therefrom.

When the hammering sound likelihood is below the threshold N6 in Step S74, the processor 31 determines that there is no hammering sound in Step S76. In this case, the processor 31 displays a message such as “Strike again” on the touch panel 37 to promote the operator hm to strike by the test hammer again. After that, the processor 31 terminates the present process, and returns to its original process. On the other hand, when the hammering sound likelihood reaches the threshold N6 or more, the processor 31 determines that there is a hammering sound (S75). After that, the processor 31 terminates the present process, and returns to its original process.

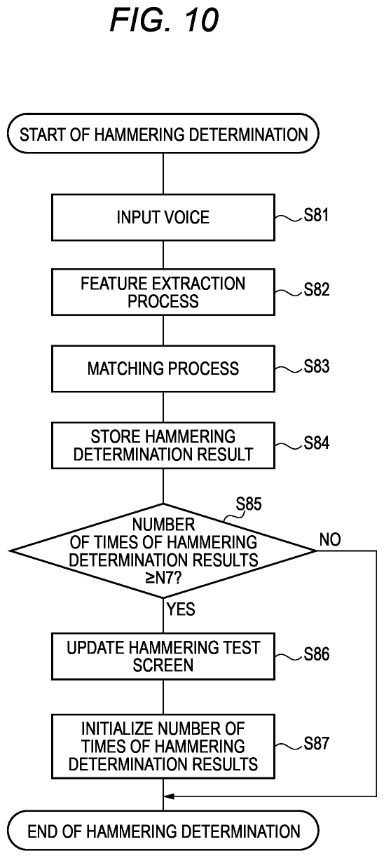

FIG. 10 is a flow chart showing a hammering determination procedure in Step S63. When determining that there is a hammering sound in Step S75, the processor 31 inputs the hammering signal data collected by the sound collection unit 11 (S81), and performs a feature extraction process of extracting features from the hammering signal data (S82). In the feature extraction process, the processor 31 performs general (known) signal processings such as normalization of sound volume (sound pressure level), Fourier transformation, mel-frequency cepstrum coefficients, noise rejection, etc. on the sound data.

The processor 31 performs a matching process of determining whether the extracted features coincide with features of hammering signal data registered in a hammering database (DB) 34z stored in the recording unit 34 (S83). When the extracted features coincide with the features of the registered hammering signal data in the matching process, the processor 31 determines that the hammering test is normal (OK). On the other hand, when the extracted features do not coincide with the features of the registered hammering signal data, the processor 31 determines that the hammering test is OK.

As a result of the matching process, the processor 31 determines whether the hammering test is normal (OK) or abnormal (NG), and stores the hammering sound determination result into the recording unit 34 (S84). The processor 31 determines whether the number of hammering determination results reaches at least a threshold N7 or not (S85). When the number of the hammering sound determination results is below the threshold N7, the processor 31 terminates the present process as it is, and returns to its original process.

On the other hand, when the number of the hammering sound determination results is on or beyond the threshold N7 in Step S85, the processor 31 updates the hammering test screen GM1 (see FIG. 14) displayed on the touch panel 37 based on the hammering determination results (S86). After updating the hammering test screen, the processor 31 initializes the number of hammering determination results (S87). After that, the processor 31 terminates the present process, and returns to its original process.

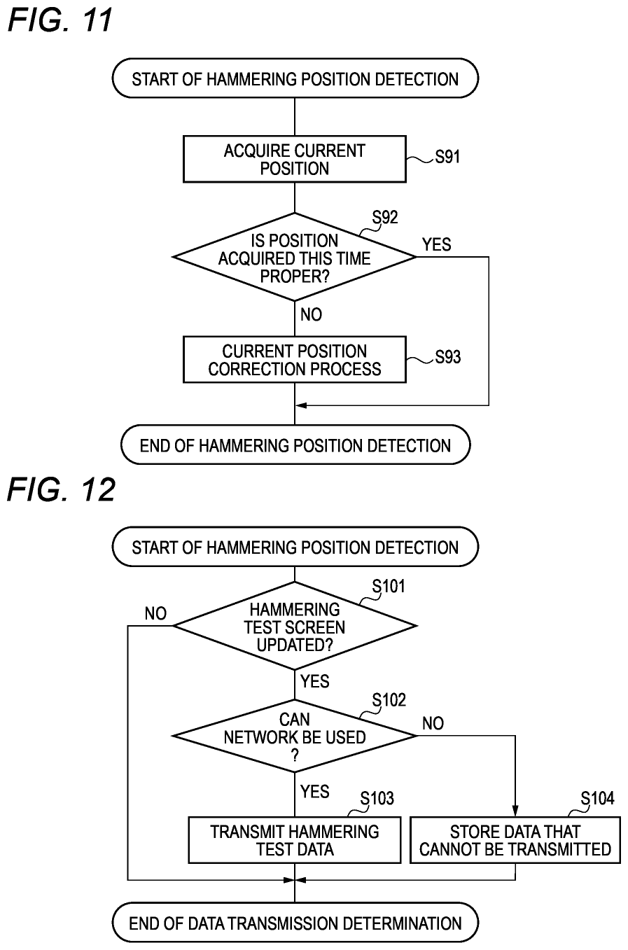

FIG. 11 is a flow chart showing a hammering position detection procedure in Step S65. The processor 31 acquires current measured position information (a latitude, a longitude, and an altitude) based on a GPS signal received by the GPS receiver 42 (S91). Based on the position information acquired at the last time and an elapsed time therefrom, the processor 31 determines whether the position information obtained at this time is suitable or not (S92). That is, when the operator hm examines a plurality of places to be hammered, time required for hammering test on each place, and time required for moving to the next place to be hammered can be generally grasped. For example, when the difference in measured coordinates between the last measurement and this measurement is X m or more and the elapsed time after the last measurement is within X seconds, the time is too short to move to the next measured coordinates. Thus, the processor 31 determines that the measured coordinates are wrong. In such a case, therefore, the processor 31 corrects the current position.

When it is determined in Step S92 that the position information acquired at this time is suitable, the processor 31 terminates the present process and returns to its original process. On the other hand, when it is determined in Step S92 that the position information acquired at this time is not suitable, the processor 31 performs a current position correction process of correcting the current position (S93). In the current position correction process, the processor 31 may correct the current position, for example, using the last measured coordinates and the coordinates measured at this time. In addition, the current position may be corrected based on a variation among coordinates measured last five times. For example, assume that coordinates measured four times of the last five times are substantially identical, and the other one is different. In this case, the processor 31 may remove the current position which is different, and obtain a current position from an average of the substantially identical coordinates measured four times. After that, the processor 31 terminates the present process and returns to its original process.

FIG. 12 is a flow chart showing a data transmission determination procedure in Step S66. In Step S86, the processor 31 determines whether the hammering test screen GM1 has been updated or not (S101) as a result of the hammering sound determination process. When the hammering test screen GM1 has not been updated, the processor 31 terminates the present process as it is, and returns to its original process.

On the other hand, when the hammering test screen GM1 has been updated in Step S101, the processor 31 determines whether the communication unit 36 is in an environment capable of using the network NW or not (S102). When the communication unit 36 is not in an environment capable of using the network NW, the processor 31 cannot perform transmission. The processor 31 stores, into the recording unit 34, the hammering signal data, the hammering determination result data and the hammering position data at this time (S104). After that, the processor 31 terminates the present process and returns to its original process.

On the other hand, when the communication unit 36 is in an environment capable of using the network NW in Step S102, the processor 31 transmits the hammering test data (including the hammering signal data, the hammering determination result data, and the hammering position data) to the cloud server 50 (S103). When transmitting the hammering signal data, the processor 31 transmits not the hammering signal data at one time but the hammering signal data at a plurality of times together. Hammering sounds within a predetermined time (for example, about 10 seconds to 30 seconds) are regarded as hammering sounds at one and the same test place, and handled as one set. Alternatively, hammering sounds at a predetermined number of times (for example, five times) are handled as one set. When the timing of transmission to the cloud server 50 is taken for every set, the communication frequency can be suppressed. A load for transmission processing on the terminal device 30 can be reduced, resulting in suppression of network traffic. In addition, the processor 31 also transmits the hammering test data which could not been transmitted before.

In addition, the data transmitted to the cloud server 50 may include determination made as OK/NG by the operator hm. In this case, the transmitted data may be voice data such as “OK” or “there is abnormality” pronounced by the operator hm. The operator hm pushes down a determination result input button included in the button 41 of the terminal device 30, and inputs the aforementioned voice data through the microphone 33. Based on the voice data, the processor 31 may perform voice recognition to acquire the contents of OK or abnormality as text information. When there is abnormality, the movement stop time may be, for example, longer than normally. It is considered that this is because it takes some time for repairing at the time of abnormality.

In addition, among one set of hammering signal data, hammering determination results may be divided into OK and NG. In this case, the processor 31 transmits, to the cloud server 50, the hammering sound determination results as learning data in associated with the respective pieces of the hammering signal data. Each hammering determination result includes, for example, OK close to NG, intermediate between OK and NG, cancellation of sound determined obviously as not hammering sound, etc. In addition, each hammering sound determination result includes a determination result of the operator hm.

Before one set of data have been completely transmitted, the operator hm may perform a cancelling operation such as pushing down a transmission stop button displayed on the touch panel 37. In this case, the processor 31 cancels the transmission data. Thus, useless transmission can be avoided. In addition, when the hammering position measured by the GPS receiver 42 moves before one set of hammering signal data have been transmitted, the processor 31 gives the operator hm an instruction to perform hammering again. Alternatively, the position coordinates measured by the GPS receiver 42 may be corrected. For example, the number of seconds elapsed after registration of the last hammering test may be counted, and then multiplied by a walking speed to calculate a moving distance. The position coordinates detected by the GPS receiver 42 is corrected in consideration of the calculated moving distance.

In addition, there may be a case where the GPS receiver 42 cannot be used. For example, position information of an entrance of a tunnel can be acquired by position coordinates detected by the GPS receiver 42. Inside the tunnel, an image of the inside of the tunnel is always taken by the camera 43 of the terminal device 30 when the operator hm is going into the tunnel. When a point whose distance from the entrance of the tunnel is known in advance comes out on the taken image, the position coordinates detected by the GPS receiver 42 is corrected based on the position information of that point. Thus, a position where the operator hm performs a hammering test may be estimated. The position coordinates of a point inside the tunnel may be registered. In this case, the position of that point may be estimated as the position where the operator hm performs a hammering test.

The communication unit 36 of the terminal device 30 makes communication with the communication unit 52 of the cloud server 50 through the network NW, and transmits the aforementioned data thereto. After that, the processor 31 terminates the present process and returns to its original process.

The processor 51 of the cloud server 50 accumulates, in the storage 54, the aforementioned data received through the communication unit 52. The processor 51 performs machine learning using the aforementioned data accumulated in the storage 54 as learning data, so as to generate a learnt model required for hammering determination by AI (Artificial intelligence). When a request to determine hammering sound is issued from the terminal device 30 to the cloud server 50, the processor 51 of the cloud server 50 may output a hammering sound determination result corresponding to inputted hammering signal data, using the generated learnt model.

FIG. 13 is a view showing the hammering test screen GM1 displayed on the touch panel 37 of the terminal device 30. On the hammering test screen GM1, an image GZ1 including a position of the last hammering, a status m1, a determination m2 of the last hammering test, a start button bn1, and a menu button bn2. The image GZ1 may be an image taken by a camera, or may be an illustration map where a map is drawn. The status m1 is blank when a test is performed for the first time. In addition, during the test, the display of the status m1 is updated as shown in FIG. 14. In FIG. 13, the fact that the test result of the hammering test performed this time is OK is displayed in the status m1. In addition, in the image GZ1, the current position, the test result at the last time, the test result at this time, and marks mk each indicating that the number of times is insufficient are drawn and superimposed on a map cz. The map cz is a map including a road which is an object to be tested, and including a road surface to be tested on the road. Of the marks mk, for example, the mark mk indicating the current position is formed as a red (white in FIG. 13) star. The mark mk indicating OK as the result of the hammering test at this time is formed as a blue (black in FIG. 13) circle. The mark mk indicating NG and repaired as the result of the hammering test at this time is formed as a gray (shown by dots in FIG. 13) triangle. The mark mk indicating OK as the result of the hammering test at the last time is formed as a yellow (white in FIG. 13) circle. The mark mk indicating NG and repaired as the result of the hammering test at the last time is formed as a yellow triangle. The mark mk indicating that the number of times is insufficient is a mark of the character “YET”.

For example, the yellow triangle (white in FIG. 13) mark mk indicating NG as the result of the hammering test at the last time and the blue (black in FIG. 13) circle mark mk indicating OK as the result of the hammering test at this time are displayed near the start mark mk indicating the current position so as to be partially superimposed thereon. The operator hm can confirm, visually and easily on the touch panel or the like, the fact that abnormality is determined in the object to be tested at the past hammering test, and the place where the past hammering test is performed.

In this manner, on the hammering test screen GM1, the hammering test results and the hammering test positions are displayed in associated with each other on the map cz. Accordingly, the operator hm who will perform a hammering test can grasp the test situation easily so that user-friendliness can be improved.

Incidentally, the image GZ1 displayed on the hammering test screen GM1 may be changed interlocking with the current position measured by the GPS receiver 42. Accordingly, the operator hm who is performing a test can grasp a hammering test position near the current position so that user-friendliness can be improved.

Further, an image of a hammered surface of an object to be tested at the time of hammering, which image is picked up by the camera 43, may be reflected on the hammering test screen GM1 while interlocking with the camera 43. In this image-pickup mode, menu items expanded by the menu button bn2 can be selected. Incidentally, the image picked up by the camera 43 may be an image (still image or moving image) taken at the moment of striking, or may be an image which is always recorded. Further, image data of the image picked up by the camera 43 may be transmitted to the cloud server 50.

FIG. 14 is a view showing the hammering test screen GM1 displayed during a hammering test on the touch panel 37 of the terminal device 30. In the hammering test screen GM1 (see FIG. 14), “during test” is displayed in the status m1 before a hammering determination result is obtained. The status m1 is updated with a message such as “OK”, “insufficient number of times”, “80% cracking”, “cavity 60”, “OK (20% cracking)”, or “strike again”. “OK” is displayed in the status m1 when hammering sound is generated a predetermined number of times within a predetermined time after the start of the test, with the result that 80% or more of the hammering sound is regarded as OK. “Insufficient number of times” is displayed in the status m1 when hammering sound is not generated the predetermined number of times within the predetermined time after the start of the test. “Strike again” is displayed in the status m1 when the number of times of striking is regarded as insufficient because OK and NG are close to 50% and 50%, or hammering signal data could not be extracted due to disturbance sound so that correct determination could not be made.

Incidentally, the aforementioned status may be reported by voice in place of the guidance on the screen. In addition, the aforementioned status may be displayed on a display worn on eyes by the operator by use of AR (Augmented Reality) technology.

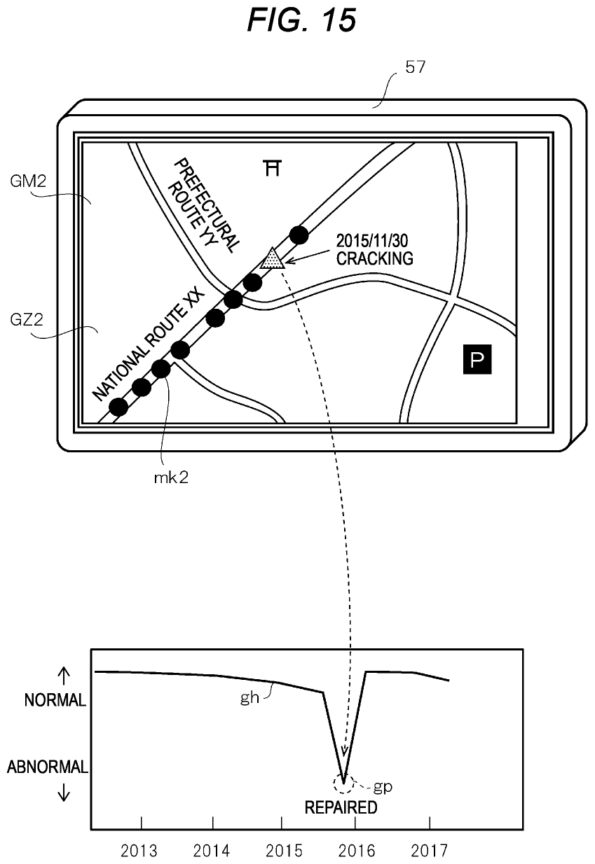

FIG. 15 is a view showing a test recording screen GM2 and a test recording graph gh displayed on the monitor 57 of the cloud server 50. The processor 51 of the cloud server 50 generates an image GZ2 in which results of hammering tests at this time are superimposed as marks mk2 on a map cz2 based on hammering determination result data and hammering position data transmitted from the terminal device 30 in Step 103. The image GZ2 may be an image picked up by a camera, or may be an illustrated map in which a map is drawn. The processor 51 displays the generated image GZ2 on the monitor 57. In the test recording screen GM2 shown in FIG. 15, the image GZ2 in which the results of the hammering tests at this time are superimposed as the marks mk2 on the map cz2 is displayed. The marks mk2 indicating the results of the hammering tests at this time and superimposed on the map cz2 are formed as blue circles excluding one place, showing the results of the hammering tests were OK. At the one place, the mark mk2 indicating the fact that the result of the hammering test at this time is NG and repairing is done is displayed as a gray triangle. In addition, “2015/11/30 cracking” is added, showing the date when the result of the hammering test is NG and the reason thereof.

The processor 51 creates the test recording graph gh indicating a history of test recording. The ordinate of the test recording graph gh designates a value in which normality (OK) and abnormality (NG) have been digitized. The higher the value is, the more normal the result is. The lower the value is, the more abnormal the result is. The abscissa of the test recording graph gh designates a test year. The test recording graph gh corresponds to the hammering position (the mark mk2 displayed as a gray triangle) displayed on the map cz2, where the hammering test at this time is NG. Due to NG in the hammering test on 2015/11/30, the digitized value enclosed by a dotted-line frame gp is low.

In this manner, in the hammering test system 5 according to Embodiment 1 or 2, the test hammer 10 to which the acceleration sensor 13 has been attached and the terminal device 30 (hammering test terminal) mounted by the operator hm (user) who grips the test hammer 10 are communicably connected to each other. The hammering test system 5 has the microphone 33 which is provided in the sound collection unit 11 provided in the test hammer 10 or in the terminal device 30. The acceleration sensor 13 acquires measured values of a speed and an inclination of the test hammer 10 when the test hammer 10 is striking the object to be tested. Based on the detection data (measured values) of the speed and the inclination of the test hammer 10 from the acceleration sensor 13, the terminal device 30 determines whether the operator hm struck the object by the test hammer 10 to be tested according to a prescribed standard or not. The terminal device 30 records, into the cloud server 50 (external device), hammering signal data collected by the sound collection unit 11 when the object to be tested is being struck according to the prescribed standard. Thus, it is possible to properly determine whether the operator struck the object to be tested properly by the test hammer or not, so that the hammering signal data in striking by the test hammer can be extracted accurately.

In addition, when determining that the object to be tested is not struck according to the prescribed standard, the terminal device 30 informs the operator hm to strike the object to be tested again. In this manner, it is possible to inform the operator to strike again in a case where the way of hammering is inadequate, so that hammering signal data obtained by an adequate way of hammering can be recorded.

In addition, when the hammering signal data is recorded in the cloud server 50, the terminal device 30 records learning data in which the hammering signal data has been associated with the measured values of the speed and the inclination of the test hammer 10. Thus, learning data which can be used for AI determination processing as to whether hammering signal data to be extracted in an adequate way of hammering according to the prescribed standard is included among collected sound signal data or not can be efficiently accumulated so that reliability in the AI determination processing can be improved.

In addition, the terminal device 30 includes the sensor 39 (first sensor) for measuring at least one parameter of temperature and humidity. The terminal device 30 records the learning data including the parameter measured by the sensor 39 during hammering according to the prescribed standard. Thus, at least one of the temperature and the humidity obtained around the operator in proper hammering is registered as the learning data, so that the reliability of the learning data can be further improved, and the reliability of the AI determination processing can be secured adequately.

In addition, based on the detection data (measured values) of the acceleration (speed) and the acceleration direction (inclination) of the test hammer 10 from the acceleration sensor 13, the terminal device 30 extracts hammering signal data to be recorded in the cloud server 50, among sound signal data collected by the sound collection unit 11. Assume that near the operator in question who grips the test hammer, another operator gripping another test hammer strikes by the test hammer and the sound collection unit collects sound signal data generated therefrom. Even in this case, hammering signal data generated in hammering by the test hammer gripped by the operator in question can be extracted accurately without being erroneously recognized. In addition, even if the operator in question forgets to perform a test start operation (such as sending a signal by voice toward a microphone or pushing down a button or an icon on UI), recording the hammering signal data can be automatically started.

In addition, the terminal device 30 further includes the acceleration sensor 38 (second sensor) for detecting a moving state of the operator hm. Accordingly, the terminal device 30 can detect stopping of the operator in question. It is therefore possible to inhibit recording of hammering signal data from being erroneously started due to movement of the test hammer when the operator does not stand still (for example, the operator is moving).

In addition, the terminal device 30 further includes a switch (input unit) included in the button 41. Through the switch, result information about the way of hammering on the object to be tested by the test hammer 10 is inputted. The terminal device 30 records the learning data including the result information into the cloud server 50. Thus, the terminal device 30 can register the learning data including the result about whether the way of hammering is good or bad depending on the subjective view of the operator hm. Therefore, sound signal data can be analyzed (for example, as to whether hammering is performed according to a prescribed standard or not) efficiently using hammering signal data obtained by a good way of hammering.

In addition, the terminal device 30 in Embodiment 1 or 2 is mounted by the operator hm who grips the test hammer 10, and communicably connected to the cloud server 50. The terminal device 30 is provided with the microphone 33, the GPS receiver 42 (measuring unit) for acquiring position information indicating the current position of the terminal device 30, the processor 31 for generating hammering test data in which hammering signal data collected by the microphone 33 when the test hammer 10 is striking the object to be tested is associated with the position information, and the communication unit 36 for transmitting the generated hammering test data to the cloud server 50. Thus, the hammering signal data obtained by the operator striking the object to be tested by the hammer can be registered in association with the information about the position where the object to be tested is struck, so that proper test management of the object to be tested existing over a wide area can be supported.

In addition, the processor 31 performs a determination process about whether the sound data collected by the sound collection unit 11 is a hammering sound or not. Based on the determination process in the position information of the terminal device 30 (that is, the operator hm), the processor 31 determines the result information indicating whether there is abnormality or not in the object to be tested struck by the test hammer 10. The communication unit 36 transmits the hammering test data including the determined result information to the cloud server 50. Thus, in accordance with whether hammering sound is included in the sound data collected in the position information of the operator hm, the terminal device 30 can determine whether there is abnormality or not based on the sound collected when the operator hm struck the object to be tested by the test hammer 10, and the result of the determination can be registered in the cloud server 50 or the like.

In addition, the processor 31 determines the result information indicating whether there is abnormality or not in the object to be tested struck by the test hammer 10, based on a voice of the operator hm collected in the position information by the sound collection unit 11. The communication unit 36 transmits the hammering test data including the determined result information to the cloud server 50. Thus, the terminal device 30 can set, easily by voice of the operator hm, whether there is abnormality or not when the operator hm struck the object to be tested by the test hammer 10, and can register the result of the determination into the cloud server 50 or the like.

In addition, the processor 31 displays, on the touch panel 37 (display unit), a mark mk (first marker) indicating the determined result information in association with the position information. Thus, the operator hm can confirm, easily and visually on the touch panel 37, whether there is abnormality or not when the object to be tested by the test hammer 10 is struck by the test hammer in the current position.

In addition, the processor 31 acquires hammering test data in a past hammering test from the cloud server 50 through the communication unit 36. When result information indicating that there is abnormality in the object to be tested is included in the hammering test data in the past hammering test, the processor 31 displays a mark mk (second marker) indicating that there is abnormality, on the touch panel 37 in association with the position information at the time of the past hammering test. Thus, the operator hm can confirm, easily and visually on the touch panel or the like, the fact that there is abnormality in the object to be tested at the time of the past hammering test, and the place where the past hammering test is performed.

In addition, based on the hammering signal data collected by the sound collection unit 11, the processor 31 determines whether the number of times of hammering on the object to be tested in the current position is below a predetermined number of times or not. According to the determination that the number of times of hammering is below the predetermined number of times, the processor 31 displays a message indicating the determination result on the touch panel 37. Thus, the operator hm can immediately grasp the fact that the number of times of hammering with the test hammer on the object to be tested in the current position is insufficient, so that the operator hm can properly perform the hammering test operation of hammering the predetermined number of times.

In addition, the processor 31 generates hammering test data in which hammering signal data collected by the sound collection unit 11 for a predetermined period when the test hammer 10 strikes the object to be tested a plurality of times is handed as one and the same set of hammering signal data in the present position of the terminal device 30. Thus, the hammering signal data in hammering for the predetermined period (such as within 30 seconds) after the start of the hammering can be registered together as the hammering test data in the same place to the cloud server or the like.

In addition, based on a voice of the operator hm in the position information where sound is collected by the sound collection unit 11, the processor 31 determines the result information indicating whether there is abnormality or not in the object to be tested in each of the plurality of times with which the object to be tested is struck by the test hammer 10 within the predetermined period. The communication unit 36 transmits the hammering test data including the determined result information in each of the times of striking, to the cloud server 50. Thus, the terminal device 30 can set, easily by the voice of the operator, whether there is abnormality or not when the operator hm struck the object to be tested by the hammer the plurality of times within the predetermined period (such as within 30 seconds), so that kinds of existence/absence of abnormality in the object to be tested can be finely classified and registered into the cloud server or the like.

In addition, the communication unit 36 transmits the hammering test data including the hammering signal data collected by the sound collection unit 11 for a predetermined period, to the cloud server 50. In this manner, as soon as hammering test data for the predetermined period (such as 30 seconds) after the start of hammering in the same present position of the hammering test terminal is generated, the hammering test data is transmitted to the cloud server or the like. Therefore, traffic through the network can be effectively reduced in comparison with that in a case where hammering test data is always transmitted continuously.

Various embodiments have been described above with reference to the drawings. Not to say, however, the present disclosure is not limited to those embodiments. It is obvious for those in the art that various examples of changes or modifications can be thought of within the categories stated in the scope of claims. It should be understood that it is a matter of course that those changes or modifications belong to the technical scope of the present disclosure.

Incidentally, the present application is based on Japanese patent applications (Japanese Patent Application No. 2018-101368 and Japanese Patent Application No. 2018-101369) filed on May 28, 2018, the contents of which are incorporated herein by reference.

### INDUSTRIAL APPLICABILITY

The present disclosure is useful because hammering signal data obtained when an operator struck an object to be tested by a hammer can be registered in association with information of a position where the operator struck the object to be tested, so that proper test management for the object to be tested existing over a wide area can be supported.

### REFERENCE SIGNS LIST

5 hammering test system
10 test hammer
11 sound collection portion
13,38 acceleration sensor
30 terminal device
33 microphone
37 touch sensor
41 button
42 GPS receiver
50 cloud server
51 processor
52 communication unit

1. A hammering test terminal which is mounted by a user gripping a hammer and which is communicably connected to an external device, comprising:
a sound collection unit;
a measuring unit that acquires position information indicating a current position of the hammering test terminal;
a processor that generates hammering test data in which hammering signal data collected by the sound collection unit when the hammer is striking an object to be tested is associated with the position information; and
a communication unit that transmits the generated hammering test data to the external device.

2. The hammering test terminal according to claim 1, wherein:
the processor performs a determination process as to whether sound data collected by the sound collection unit is a hammering sound or not, and determines result information indicating whether there is abnormality or not in the object to be tested struck by the hammer, based on the determination process in the position information; and
the communication unit transmits the hammering test data including the determined result information to the external device.

3. The hammering test terminal according to claim 1, wherein:
the processor determines result information indicating whether there is abnormality or not in the object to be tested struck by the hammer, based on a voice of the user in the position information where sound is collected by the sound collection unit; and
the communication unit transmits the hammering test data including the determined result information to the external device.

4. The hammering test terminal according to claim 2, wherein:
the processor displays a first marker indicating the determined result information and the position information in association with each other on a display unit.

5. The hammering test terminal according to claim 4, wherein:
the processor acquires the hammering test data at a past hammering test from the external device through the communication unit; and
when result information indicating that there is abnormality in the object to be tested is included in the hammering test data at the past hammering test, a second marker indicating that there is an abnormality is displayed on the display unit in association with position information at the past hammering test.

6. The hammering test terminal according to claim 4, wherein:
the processor determines whether a number of times of hammering on the object to be tested in the current position is below a predetermined number of times or not, based on the hammering signal data collected by the sound collection unit; and
in accordance with determination that the number of times of hammering is below the predetermined number of times, a message indicating a result of the determination is displayed on the display unit.

7. The hammering test terminal according to claim 1, wherein:
the processor generates the hammering test data in which the hammering signal data collected by the sound collection unit for a predetermined period when the hammer strikes the object to be tested a plurality of times is handled as one and the same set of hammering signal data in a current position of the hammering test terminal.

8. The hammering test terminal according to claim 7, wherein:
the processor determines result information indicating whether there is abnormality in the object to be tested in each of the plurality of times with which the object to be tested is struck by the hammer within the predetermined period, based on a voice of the user in the position information where sound is collected by the sound collection portion; and
the communication unit transmits the hammering test data including the determined result information at each time of hammering, to the external device.

9. The hammering test terminal according to claim 7, wherein:
the communication unit transmits the hammering test data including the hammering signal data collected by the sound collection unit for the predetermined period, to the external device.

10. A hammering test system comprising:
the hammering test terminal according to claim 1, and
the hammer to be gripped by the user, wherein:
the hammer further includes an acceleration sensor;
the acceleration sensor acquires measured values of a speed and an inclination of the hammer when the hammer struck the object to be tested;
the sound collection unit is provided in the hammer or the hammering test terminal;
the hammering test terminal determines whether the user struck the object to be tested by the hammer according to a predetermined standard or not, based on the measured values of the speed and the inclination of the hammer from the acceleration sensor; and
the hammering test terminal records, into the external device, hammering signal data collected by the sound collection unit when the object to be tested is being struck according to the predetermined standard.

11. The hammering test system according to claim 10, wherein:
the hammering test terminal informs the user to strike the object to be tested again when the object to be tested is not struck according to the predetermined standard.

12. The hammering test system according to claim 10, wherein:
the hammering test terminal records learning data in which the hammering signal data is associated with the measured values of the speed and the inclination of the hammer, when the hammering signal data is recorded into the external device.

13. The hammering test system according to claim 12, wherein:
the hammering test terminal includes a first sensor that measures at least one parameter of temperature and humidity; and
the hammering test terminal records the learning data including the parameter measured by the first sensor in hammering according to the predetermined standard.

14. The hammering test system according to claim 10, wherein:
the hammering test terminal extracts the hammering signal data to be recorded into the external device, among sound signal data collected by the sound collection unit, based on the measured values of the speed and the inclination of the hammer from the acceleration sensor.

15. The hammering test system according to claim 10, wherein:
the hammering test terminal further includes a second sensor that detects a moving state of the user.

16. The hammering test system according to claim 12 or 13, further comprising:
an input unit through which result information about a way of striking the object to be tested by the hammer is inputted; wherein:
the hammering test terminal records the learning data including the result information into the external device.

17. A hammering test data registration method in a hammering test terminal which is mounted by a user gripping a hammer and which is communicably connected to an external device, the hammering test data registration method comprising:
acquiring position information indicating a current position of the hammering test terminal;
collecting sound by a sound collection unit:
generating hammering test data in which hammering signal data collected by the sound collection unit when the hammer is striking an object to be tested is associated with the position information; and
transmitting the generated hammering test data to the external device.

18. The hammering test data registration method according to claim 17, further comprising:
performing a determination process as to whether sound data collected by the sound collection unit is a hammering sound or not, and determines result information indicating whether there is abnormality or not in the object to be tested struck by the hammer, based on the determination process in the position information; and
transmitting the hammering test data including the determined result information to the external device.

19. The hammering test data registration method according to claim 17, further comprising:
determining result information indicating whether there is abnormality or not in the object to be tested struck by the hammer, based on a voice of the user in the position information where sound is collected by the sound collection unit; and
transmitting the hammering test data including the determined result information to the external device.

20. The hammering test data registration method according to claim 18, further comprising:
displaying a first marker indicating the determined result information and the position information in association with each other on a display unit.

21. The hammering test data registration method according to claim 20, further comprising:
acquiring the hammering test data at a past hammering test from the external device; and
when result information indicating that there is abnormality in the object to be tested is included in the hammering test data at the past hammering test, displaying a second marker indicating that there is an abnormality, on the display unit in association with position information at the past hammering test.

22. The hammering test data registration method according to claim 20, further comprising:
determining whether a number of times of hammering on the object to be tested in the current position is below a predetermined number of times or not, based on the hammering signal data collected by the sound collection unit; and
in accordance with determination that the number of times of hammering is below the predetermined number of times, displaying a message indicating a result of the determination on the display unit.

23. The hammering test data registration method according to claim 18, further comprising:
generating the hammering test data in which the hammering signal data collected by the sound collection unit for a predetermined period when the hammer strikes the object to be tested a plurality of times is handled as one and the same set of hammering signal data in a current position of the hammering test terminal.

24. The hammering test data registration method according to claim 23, further comprising:
determining result information indicating whether there is abnormality or not in the object to be tested in each of the plurality of times with which the object to be tested is struck by the hammer within the predetermined period, based on a voice of the user in the position information where sound is collected by the sound collection portion; and
transmitting the hammering test data including the determined result information at each time of hammering, to the external device.

25. The hammering test data registration method according to claim 23, further comprising:
transmitting the hammering test data including the hammering signal data collected by the sound collection unit for the predetermined period, to the external device.

26. The hammering test data registration method according to claim 18, wherein:
the hammer further includes an acceleration sensor;
the acceleration sensor acquires measured values of a speed and an inclination of the hammer when the hammer struck the object to be tested; and
the sound collection unit is provided in the hammer or the hammering test terminal, and
the hammering test data registration method further comprising:
determining whether the user struck the object to be tested by the hammer according to a predetermined standard or not, based on the measured values of the speed and the inclination of the hammer from the acceleration sensor; and
recording, into the external device, hammering signal data collected by the sound collection unit when the object to be tested was being struck according to the predetermined standard.

27. The hammering test data registration method according to claim 26, further comprising:
informing the user to strike the object to be tested again when the object to be tested was not struck according to the predetermined standard.

28. The hammering test data registration method according to claim 26, further comprising:
recording learning data in which the hammering signal data is associated with the measured values of the speed and the inclination of the hammer, when the hammering signal data is recorded into the external device.

29. The hammering test data registration method according to claim 28, wherein:
the hammering test terminal further includes a first sensor that measures at least one parameter of temperature and humidity, and
the hammering test data registration method further comprising:
recording the learning data including the parameter measured by the first sensor in hammering according to the predetermined standard.

30. The hammering test data registration method according to claim 26, further comprising:
extracting the hammering signal data to be recorded into the external device, among sound signal data collected by the sound collection unit, based on the measured values of the speed and the inclination of the hammer from the acceleration sensor.

31. The hammering test data registration method according to claim 26, wherein:
the hammering test terminal further includes a second sensor that detects a moving state of the user.

32. The hammering test data registration method according to claim 28, wherein:
the hammering test terminal further includes an input unit through which result information about a way of striking the object to be tested by the hammer is inputted, and
the hammering test data registration method further comprising:
recording the learning data including the result information into the external device.

33. The hammering test terminal according to claim 3, wherein:
the processor displays a first marker indicating the determined result information and the position information in association with each other on a display unit.

34. The hammering test data registration method according to claim 19, further comprising:
displaying a first marker indicating the determined result information and the position information in association with each other on a display unit.
